(19) United States
(12) Patent Application Publication
(10) Pub. No.: US 2021/0148473 A1
(43) Pub. Date: May 20, 2021

(54) LEAK PROOF NON RETURN VALVE

(71) Applicant: PADMINI VNA MECHATRONICS PVT. LTD., Gurgaon, Haryana (IN)

(72) Inventors: KABIR BHANDARI, GURGAON (IN); AMARDIP KUMAR, GURGAON (IN); VARUN KUMAR, GURGAON (IN)

(21) Appl. No.: 16/622,957

(22) PCT Filed: Jun. 15, 2018
(86) PCT No.: PCT/IB2018/054424

§ 371 Date: Dec. 16, 2019

(30) Foreign Application Priority Data
Jun. 15, 2017 (IN) 201711020893

(51) Int. Cl. F16K 15/02; F16K 15/14; F16K 27/02

(52) U.S. Cl. CPC F16K 15/026; F16K 27/0209; F16K 15/148

(57) ABSTRACT

The present invention relates to a non return valve, having a supporting structure in cap part (upper body portion) such as but not limited to a wall or any extrusion for better and improved self assembly and eliminates the leakage of the non return valve due to weld flash at sealing surface. In addition, a filter unit, which is either inbuilt or insert molded that can be assembled within the closed state of fully assembled non return valve unit. The present invention also relates to non return valve includes a cap (upper body portion), a filter, a diaphragm, a base for diaphragm, a compression spring, and a bottom body (lower body portion).

### FIELD OF THE INVENTION

The present invention provides a leak proof non-return valve a non return valve with self supported structure and a molded filter unit for improved self assembly. More particularly, the invention provides a support structure incorporated in cap and an inbuilt or insert molded filter unit that is assembled within the closed state of fully assembled non return valve unit.

### BACKGROUND OF THE INVENTION

A non-return valve comprises of a plurality of parts such as body or bodies with provision for fluid inlet and outlet, a cap (upper body portion) with nozzle, a bottom body (lower body portion) with nozzle, a spring and a diaphragm. Further, in order to complete a functional assembly all the parts are either fastened and/or welded. More particularly, cap and bottom body are sealed (fasten or welded) together and rest of parts housed into said sealed assembly. In addition, it is a well known art of configuring non return valve with other auxiliary equipments or devices such as filter assembly, etc. to facilitate clean fluid into the system.

In general, a non return valve is incorporated within a fluid line circuit, wherein fluid is passed through it in a one direction. In any such system or application, where non-return valve is incorporated, it is required that all parts of non return valve must be sealed perfectly without affecting the functionality of its inner configuration. Therefore, in any system it is strongly recommended that there must be a tight seal to prevent leakage of fluid from non return valve, as any faulty arrangement might cause loss of fluid, which can lead to malfunctioning of other parts, improper functioning of other expensive and sensitive parts.

At present conventional method like ultrasonic welding is used for joining the body or bodies of non-return valve. Ultrasonic welding is an industrial technique whereby high-frequency ultrasonic acoustic vibrations are locally applied to fuse the work pieces under pressure also known as a solid-state weld. The method is a well known technique and has evolved with time, to be more precise and energy efficient. Although, it is possible to use other state of the art methods for getting a leak proof seal, it is required that the geometry, design and shape of pieces to be joined must be well engineered with suitable tolerances and finish of the parts for smooth operation suitable clearances and tolerances, good finish and smooth operation. The unfiltered fluid is transported through the fluid line circuit, therefore auxiliary equipments or devices such as filter assembly is coupled with non return valve, which filters any or all unwanted particles to reach or travel to the other parts of the system. Additional separate filter assembly to the non return valve is not ergonomic as this leads to the more dependency on system.

On the other hand poorly designed assembly of non-return valve with no separation between sealing zone and welding zone may allow entry of contamination of the welding in the sealing zone which will cause leakage of fluid from NRV. Further ultrasonic welding, with improper contact between cap sealing surface and diaphragm may also result in leakage of non-return valve.

Based on the forgoing, a need exists for an improved parts design of a non return valve. Further, in improved part design a filter disc can be incorporated within the internal assembly which improves the ergonomic of basic design.

### OBJECT OF THE INVENTION

The main object of the present invention is to eliminate the leakage of the non return valve due to weld flash at sealing surface.

Yet another object of the present invention is to provide a non return valve with self supported structure which is easy to assemble.

Yet another object of the present invention is to add a protective wall in cap part.

Yet another object of the present invention is to separate the welding and the sealing zone.

Yet another object of the present invention is to prevent the weld contaminations to enter inside the sealing zone during welding or during operation of non return valve.

Yet another object of the present invention is to provide an insert molded filter which filters the unwanted particles to reach or travel to the other parts of the system.

Yet another object of the present invention is to provide an inbuilt/insert molded filter in the cap of non return valve, which reduce the assembly errors in a very cost effective manner.

### SUMMARY OF THE INVENTION

The present invention relates to a non return valve, having a supporting structure in cap part (upper body portion) such as but not limited to a wall or any extrusion for better and improved self assembly and eliminates the leakage of the non return valve due to weld flash at sealing surface. In addition, a filter unit, which is either inbuilt or insert molded that can be assembled within the closed state of fully assembled non return valve unit.

In one embodiment of the present invention, a non return valve includes a cap (upper body portion), a filter, a diaphragm, a base for diaphragm, a compression spring, and a bottom body (lower body portion).

In another embodiment of the present invention, a protective wall is made into cap (upper body portion) which separate welding and sealing surface and eliminate the leakage of the non return valve due to weld flash at sealing surface.

In another embodiment of the present invention, a non return valve includes an inbuilt or inserts molded filter part for filtrate the (unwanted) particles coming into the fluid.

### BRIEF DESCRIPTION OF THE DRAWINGS

The present invention will be described with reference to the following drawings. The drawings and the associated descriptions are provided to illustrate embodiments of the invention and not to limit the scope of the invention:

FIG. 1 is an exploded view of a non return valve in accordance with an embodiment of the present invention;

FIG. 2 is a perspective view of cap part (upper body portion) in accordance with an embodiment of the present invention;

FIG. 3 is a perspective bottom view of cap part (upper body portion) in accordance with an embodiment of the present invention;

FIG. 4 is a sectional view a non return valve in accordance with an embodiment of the present invention; and

FIG. 5 is a top view of inbuilt/insert molded filter unit in accordance with an embodiment of the present invention.

### DETAILED DESCRIPTION OF THE INVENTION

The present invention now will be described more fully hereinafter with reference to the accompanying drawings. While the following description details the preferred embodiments of the present invention is not limited in its application to the details of construction and arrangement of the parts illustrated in the accompanying drawings. With reference to the figures, numerical designation has been given for each element to facilitate the reader's understanding of the present invention, and particularly with reference to the embodiments of the present invention illustrated in the figures. The enclosed description and drawings are merely illustrative of preferred embodiments. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

In one embodiment of present invention provides a non return valve, having a supportive structure in cap part (upper body portion) such as but not limited to a wall or any extrusion for better and improved self assembly and eliminates the leakage of the non return valve due to weld flash at sealing surface. In addition, a filter unit, which is either inbuilt or insert molded that can be assembled within the closed state of fully assembled non return valve unit.

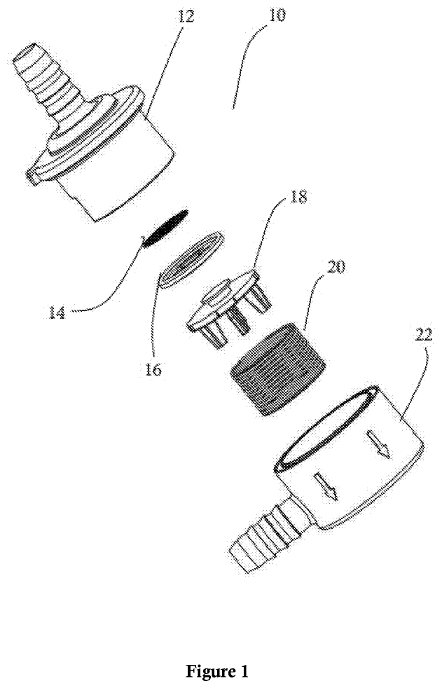

Now referring to FIG. 1, in one embodiment, the present invention provides a non return valve 10 includes, a cap 12 (upper body portion) is generally circular in shape and includes an elongate nozzle, an extremely thin filter 14 for preventing unwanted contents to flow further into the line, a diaphragm 16 which is constructed in a flexible material, a base 18 for securing diaphragm 16 within the assembly, a compression spring 20 which kept the pressure on base 18 ensures that in elongated condition obstructs or closes the aperture to prevent fluid flowing in a reverse direction towards the inlet and a bottom body 22 is generally circular in shape and includes an elongate nozzle.

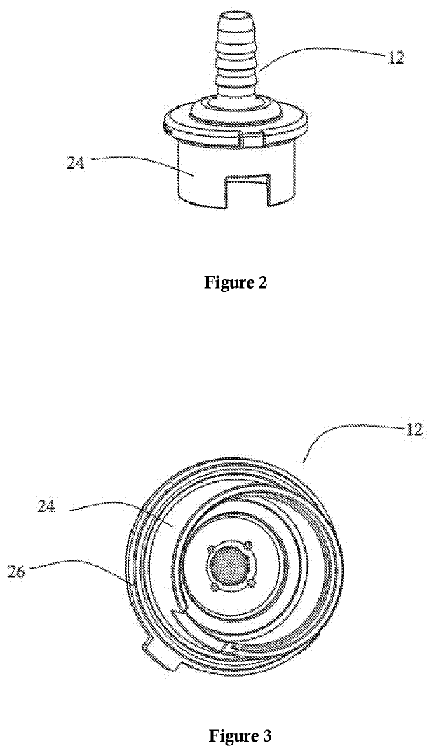

Now referring to FIG. 2, in one embodiment, the present invention provides a cap 12 (upper body portion) is generally circular in shape and includes an elongate nozzle. Further cap 12 is provided with an elongated or extruded surface 24 which separate welding and sealing surface and eliminate the leakage of the non return valve due to weld flash at sealing surface.

Now referring to FIG. 3, in one embodiment, the present invention provides a cap 12 (upper body portion) is generally circular in shape and includes an elongate nozzle. Further cap 12 having a welding flange 26 having extrusion around its circumference for (welding)/locking with bottom body 22.

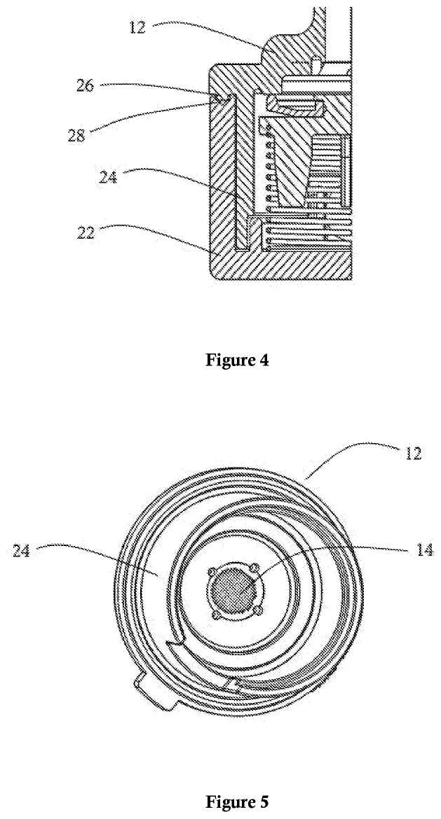

Now referring to FIG. 4, in one embodiment, showing the sectional view of non return valve 10, showing a cap 12 having a welding flange 26 which is contact with welding flange 28 of bottom body 22. Welding flange 28 have groove around its circumference for (welding) locking with cap 12. Once the whole assembly of non return valve 10 is completed, it is put into a fixture for welding. During welding both the flanges are subject to pressure and heat and get fused. During this welding process (weld particle) molten material flows towards the internal of assembly, but since there is an elongated or extruded surface 24 which separate welding and sealing surface, thus resist the flow of molten material and weld flash inside the assembly at sealing surface. This ensures a good welding whole around the flanges and eliminates the leakage of the non return valve. Further, kept the internal parts functioning smooth and jerk free.

Now referring to FIG. 5, in one embodiment, showing a cap 12 in which a molded filter unit 14 is assembled. The said filter unit 14 can be inbuilt with cap 12 during molding process of cap's “upper body portion”.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

We claim:

1. A non-return valve 10, comprising:
a cap 12 (upper body portion) having an elongated nozzle for allowing;
a filter 14 for filtering unwanted contents from the fluid;
a flexible diaphragm 16 secured to a base unit 18 to allow the fluid to compress a compression spring 20 in forward direction when fluid is coming through the nozzle of a cap 12 (upper body portion) and also ensure that in elongated condition of compression spring 20 obstructs or closes the aperture/nozzle of a cap 12 (upper body portion) to prevent fluid flowing in a reverse direction; and
a bottom body 22 (lower body portion) with an elongated nozzle and grooved welding flange 28, wherein;
an elongated or extruded surface 24 separates welding and sealing surface and eliminates the leakage of the non return valve 10;
an elongated or extruded surface 24 is made into cap (upper body portion) along with its welding flange 26; and
a filter can be inbuilt or inserts molded type to filter (unwanted) particles coming into the fluid.

2. The non-return valve 10 as claimed in claim 1, wherein the non return valve can optionally be provided with a wall or any extrusion for better and improved self assembly.

3. The non-return valve 10 as claimed in claim 1, wherein the non return valve is provided with a filter unit, either inbuilt or insert molded that can be assembled within the closed state of fully assembled non return valve 10.
